(19) United States
(12) Patent Application Publication
(10) Pub. No.: US 2010/0082967 A1
(43) Pub. Date: Apr. 1, 2010

(54) METHOD FOR DETECTING MEMORY TRAINING RESULT AND COMPUTER SYSTEM USING SUCH METHOD

(75) Inventor: NAN-KUN LO, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTek COMPUTER INC., Taipei (TW)

(21) Appl. No.: 12/566,047

(22) Filed: Sep. 24, 2009

(30) Foreign Application Priority Data
Sep. 26, 2008 (TW) 097137238

(51) Int. Cl. G06F 15/177; G06F 12/00

(52) U.S. Cl. 713/2; 711/103; 711/E12.001; 711/E12.008

(57) ABSTRACT

A method for detecting a memory training result includes the following steps. Firstly, a computer system is booted. Then, a memory training program included in a basic input output system of the computer system is executed, thereby obtaining a plurality of reading time parameters and a plurality of writing time parameters. Afterwards, the reading time parameters and the writing time parameters are recorded into a non-volatile memory. The computer system includes a central processing unit, a memory device, a chipset, a basic input output system, and a non-volatile memory. The memory device includes a memory module. The chipset is connected to the memory module and the central processing unit, and includes a memory controller. The basic input output system is connected to the chipset and includes a memory training program. The non-volatile memory is connected to the chipset.

### FIELD OF THE INVENTION

The present invention relates to a method of detecting a memory training result, and more particularly to a method of detecting a memory training result in a computer system. The present invention also relates to a computer system using such a method.

### BACKGROUND OF THE INVENTION

Generally, a memory controller is mounted on a motherboard of a computer system. The memory controller could be integrated into a north bridge chip or a central processing unit (CPU). A memory module such as a dual in-line memory module (DIMM) is usually plugged into a memory module insertion slot (e.g. a DIMM insertion slot) of the motherboard. As such, the memory controller and the memory module could exchange data with each other.

Generally, the memory controller and the memory module insertion slot are soldered on the motherboard. In addition, the memory controller and the memory module insertion slot are electrically connected with each other via metallic traces of the motherboard. The memory module has a daughter board. An edge of the daughter board has gold fingers to be plugged into the memory module insertion slot. For example, a plurality of memory chips such as dynamic random access memory (DRAM) chips are mounted on the daughter board. Similarly, these DRAM chips and the gold fingers are electrically connected with each other via metallic traces.

When the memory controller issues a write command, the data are transmitted from the memory controller to the DRAM chips and stored in the DRAM chips. Whereas, when the memory controller issues a read command, the data are transmitted from the DRAM chips to the memory controller and transferred to the CPU for processing.

Take a double data rate (DDR) memory module or a double data rate dual in-line memory module (DDR DIMM) for example. A DDR transaction will be illustrated in more details as follows.

First of all, a command is sent out from the memory controller through command lines and address lines. At the next command clock, all DDR memory modules will read the command from the command lines and the address lines and a specified DDR memory module associated with this command is determined. Next, all DRAM chips of this specified DDR memory module will be ready for storing or reading data according to this command.

In a case that the command is a read command, all DRAM chips of this specified DDR memory module will begin to drive the data signal (DQ) and the data strobe signal (DQS). In another case that the command is a write command, the DQ signal and the DQS signal are driven by the memory controller. Meanwhile, the DQ signal and the DQS signal start toggling. Generally, a memory module having eight DRAM chips get a total of 64 DQ lines and a total of 8 DQS lines. The DQ signal is related to data transmission, while the DQS signal is related to data clock transmission.

FIGS. 1A and 1B are schematic diagrams illustrating the signals processed in DDR memory modules according to the prior art. Generally, a memory controller 300 could control four DDR memory modules. For clarification and brevity, only two DDR memory modules 100 and 200 are shown in the drawings.

As shown in FIG. 1A, the memory controller 300 issues four command clock signals (CMDCLK0, CMDCLK1, CMDCLK2, CMDCLK3), four chip select signals (CS0, CS1, CS2, CS3), several command signals and several address signals. In addition, the first DDR memory module 100 comprises eight DRAM chips 101˜108 and a register 120. The second DDR memory module 200 comprises eight DRAM chips 201˜208 and a register 220. The first DDR memory module 100 and the second DDR memory module 200 are plugged into a first memory module insertion slot 150 and a second memory module insertion slot 250, respectively. The command signals and address signals issued by the memory controller 300 include for example address signal A0˜A13, a row address strobe (RAS) signal, a column address strobe (CAS) signal and a write enable (WE) signal. These command signals and address signals could be transmitted to the register 120 of the first DDR memory module 100 and the register 220 of the second DDR memory module 200.

The four command clock signals CMDCLK0˜CMDCLK3 and the four chip select signals CS0˜CS3 issued by the memory controller 300 are transmitted to the registers of the four DDR memory modules, respectively. According to the signals shown in FIG. 1A, the read addresses or the write addresses of the DRAM chips 101˜108 of the first DDR memory module 100 or the DRAM chips 201˜208 of the second DDR memory module 200 will be realized.

In FIG. 1B, the DQ signals and the DQS signals issued by the DDR memory modules will be illustrated in more details. The first DDR memory module 100 comprises eight DRAM chips 101˜108, and the second DDR memory module 200 comprises eight DRAM chips 201˜208. Each DRAM chip is connected with 8 DQ lines and 1 DQS line. The 8 DQ lines are collectively referred as a byte lane. That is, the data transmission speed of one byte lane is controlled by a corresponding DQS line.

Please refer to FIG. 1B again. The first DRAM chip 101 of the first DDR memory module 100 and the first DRAM chip 201 of the second DDR memory module 200 are connected to the DQ0˜DQ7 signals and the DQS0 signal. The second DRAM chip 102 of the first DDR memory module 100 and the second DRAM chip 202 of the second DDR memory module 200 are connected to DQ8˜DQ15 signals and the DQS1 signal. The third DRAM chip 103 of the first DDR memory module 100 and the third DRAM chip 203 of the second DDR memory module 200 are connected to DQ16˜DQ23 signals and the DQS2 signal. The fourth DRAM chip 104 of the first DDR memory module 100 and the fourth DRAM chip 204 of the second DDR memory module 200 are connected to DQ24˜DQ31 signals and the DQS3 signal. The fifth DRAM chip 105 of the first DDR memory module 100 and the fifth DRAM chip 205 of the second DDR memory module 200 are connected to DQ32˜DQ39 signals and the DQS4 signal. The sixth DRAM chip 106 of the first DDR memory module 100 and the sixth DRAM chip 206 of the second DDR memory module 200 are connected to DQ40˜DQ47 signals and the DQS5 signal. The seventh DRAM chip 107 of the first DDR memory module 100 and the seventh DRAM chip 207 of the second DDR memory module 200 are connected to DQ48˜DQ55 signals and the DQS6 signal. The eighth DRAM chip 108 of the first DDR memory module 100 and the eighth DRAM chip 208 of the second DDR memory module 200 are connected to DQ56˜DQ63 signals and the DQS7 signal.

For example, according to a read command for reading the first DDR memory module 100, the DRAM chips 101˜108 of the first DDR memory module 100 will drive the DQ0˜DQ63 signals and the DQS0˜DQS7 signals. Whereas, according to a write command for writing the first DDR memory module 100, the DQ0˜DQ63 signals and the DQS0˜DQS7 signals are driven by the memory controller 300. Meanwhile, the DQ0˜DQ63 signals and the DQS0˜DQS7 signals start toggling.

FIG. 2A is a timing waveform diagram illustrating the related DQ and DQS signals processed in the transmitters of FIG. 1. According to the specifications of DDR memory modules, the DQ and DQS signals should be aligned with each other during data transmission. Take the DQ0˜DQ7 signals and the DQS0 signal for example. The data of the DQ0˜DQ7 signals should be aligned with the rising edges and the falling edges of the DQS0 signal. In other words, according to a read command, all DRAM chips are deemed as transmitters for outputting the DQ and DQS signals, while the memory controller is deemed as a receiver for receiving the DQ and DQS signals. On the other hand, according to the read command, the memory controller is deemed as a transmitter for outputting the DQ and DQS signals, while all DRAM chips are deemed as receivers for receiving the DQ and DQS signals. The DQ and DQS signals outputted from the transmitters should be aligned with each other.

As known, the commercially available memory modules are obtained from many manufacturers. If the memory modules available from different manufacturers are plugged into the memory module insertion slots of the same motherboard of a computer system, some problems are possibly incurred. For example, if the DRAM chips and/or the layout configurations of the daughter boards of different memory modules are very distinguished, the propagation delays of all signals are not consistent. Under this circumstance, the data fail to be accurately read out or written into the DRAM chips.

FIG. 2B is a timing waveform diagram illustrating the related DQ and DQS signals processed in the receivers of FIG. 1. When the DQ0˜DQ7 signals and the DQS0 signal are transmitted to the receivers, the DQ0˜DQ7 signals usually fail to be aligned with the DQS0 signal. For example, as shown in FIG. 2B, the DQ6 signal has a considerable propagation delay. As a consequence, the data of the DQ6 signal may fail to be accurately read out or written into the DRAM chips. Under this circumstance, the operations of the memory modules are abnormal.

Moreover, for complying with diverse memory modules, the designer of the motherboard needs to purchase various memory modules from different memory module manufacturers. These various memory modules are successively plugged into the memory module insertion slots of the motherboard in order to test these memory modules. Due to the difference between the daughter boards of supporting different memory modules, the difference between the DRAM chips and the speed difference, some memory modules fail to be successfully read out or written in.

For solving the above drawbacks, all signal lines of the memory module insertion slots of the motherboard are usually connected to an oscilloscope by the designer of the motherboard. Via the oscilloscope, the designer of the motherboard could realize the quality of all signals during the process of testing the memory modules. For example, if the testing result of executing the write command or the read command indicates that the DQ6 signal is unqualified (that is, the DQ6 signal fails to be read or written), the designer of the motherboard needs to analyze the relationship between the DQ6 signal and the DQS0 signal. Since the DQ6 signal and the DQS0 signal are not aligned with each other, the memory controller or the DRAM chips fail to accurately read out the data of the DQ6 signal. In other words, the designer of the motherboard could only realize the relationship between the DQ6 signal and the DQS0 signal according to the testing result shown on the oscilloscope, thereby implementing associated troubleshooting process.

As the types of memory modules are more and more diverse, the processes for testing and troubleshooting the memory modules become very troublesome and inefficient. Under this circumstance, the delivery time of the motherboard from the factory is usually delayed.

### SUMMARY OF THE INVENTION

In accordance with an aspect of the present invention, there is provided a method for detecting a memory training result. The method includes the following steps. Firstly, a computer system is booted. Then, a memory training program included in a basic input output system of the computer system is executed, thereby obtaining a plurality of reading time parameters and a plurality of writing time parameters. Afterwards, the reading time parameters and the writing time parameters are recorded into a non-volatile memory.

In accordance with another aspect of the present invention, there is provided a computer system for recording a memory training result. The computer system includes a central processing unit, a memory device, a chipset, a basic input output system, and a non-volatile memory. The memory device includes a memory module. The chipset is connected to the memory module and the central processing unit, and includes a memory controller. The basic input output system is connected to the chip set and includes a memory training program. The non-volatile memory is connected to the chipset. During the booting of the computer system, the central processing unit executes the memory training program to obtain a plurality of reading time parameters and a plurality of writing time parameters. The reading time parameters and the writing time parameters are recorded into the non-volatile memory.

In accordance with a further aspect of the present invention, there is provided a computer system for recording a memory training result. The computer system includes a central processing unit, a memory device, a chipset, a basic input output system, and a non-volatile memory. The central processing unit includes a memory controller. The memory device is connected to the central processing unit, and includes a memory module. The chipset is connected to the central processing unit. The basic input output system is connected to the chipset and includes a memory training program. The non-volatile memory is connected to the chipset. During the booting of the computer system, the central processing unit executes the memory training program to obtain a plurality of reading time parameters and a plurality of writing time parameters. The reading time parameters and the writing time parameters are recorded into the non-volatile memory.

### BRIEF DESCRIPTION OF THE DRAWINGS

The above contents of the present invention will become more readily apparent to those ordinarily skilled in the art after reviewing the following detailed description and accompanying drawings, in which:

FIGS. 1A and 1B are schematic diagrams illustrating the signals processed in DDR memory modules according to the prior art;

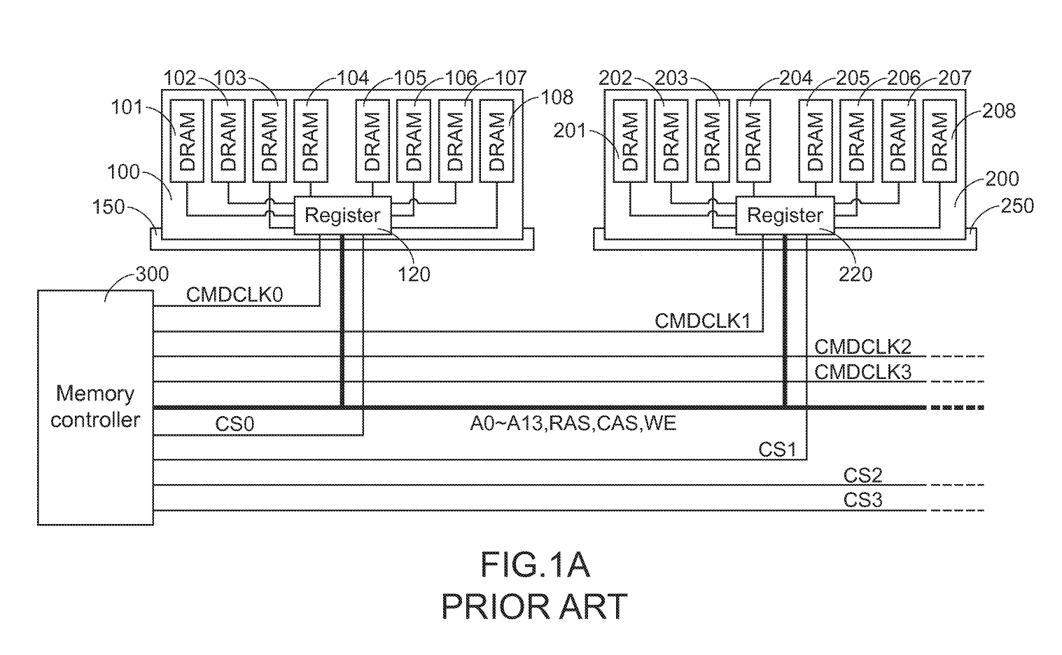

FIG. 2A is a timing waveform diagram illustrating the related DQ and DQS signals processed in the transmitters of FIG. 1;

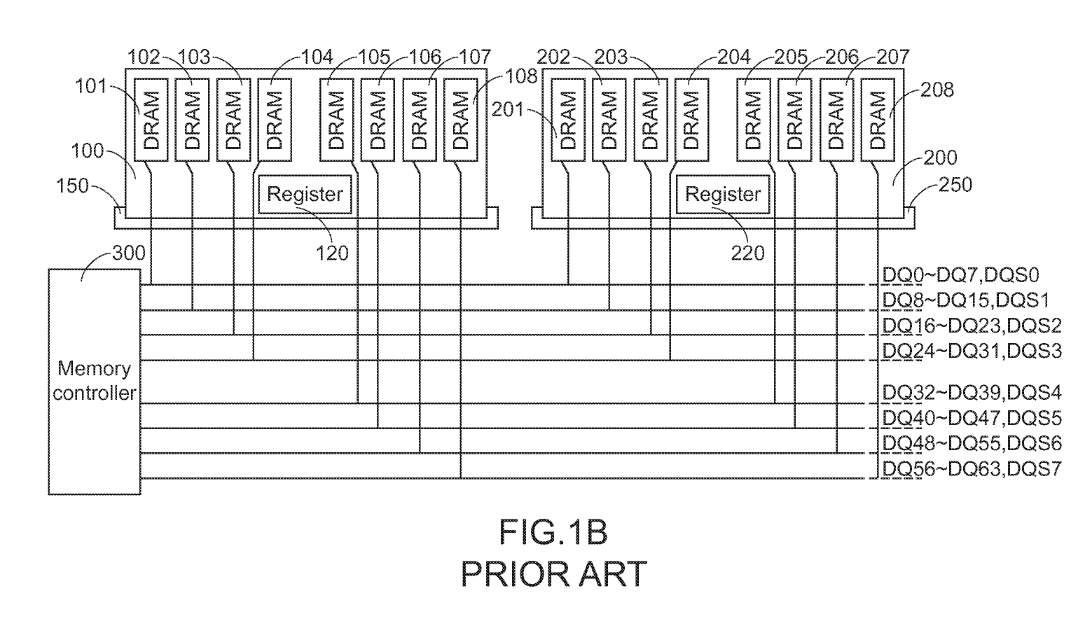

FIG. 2B is a timing waveform diagram illustrating the related DQ and DQS signals processed in the receivers of FIG. 1;

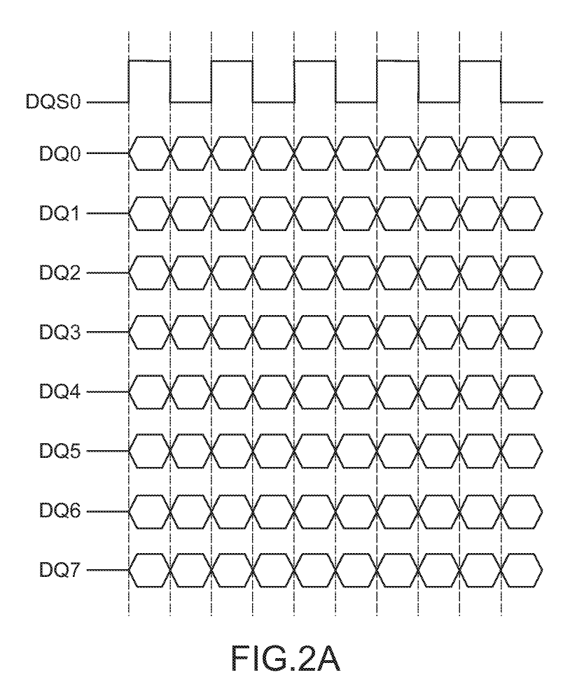

FIG. 3 is a timing waveform diagram illustrating the related DQ and DQS signals processed by the read DQ signal training procedure and the read DQS signal training procedure according to the present invention;

FIG. 4A is a schematic functional block diagram illustrating a computer system for recording the memory training result according to a first embodiment of the present invention;

FIG. 4B is a schematic functional block diagram illustrating a computer system for recording the memory training result according to a second embodiment of the present invention; and

FIG. 5 is a flowchart schematically illustrating a method of detecting the memory training result of the computer system according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

Generally, according to the motherboard manufacturer's design, the basic input output system (BIOS) of a computer system usually includes a memory training program to help people sustainably improve their working memory capacity. During the initialization of the computer system, the memory training program included in the BIOS will be executed by the CPU. After the memory training program has been executed, the memory modules will be successfully read out or written in.

After the memory training program has been executed, the propagation delays of respective DQ and DQS signals are controlled by the memory controller, so that the DQ and DQS signals in the receivers are aligned with each other. As a consequence, the memory training program can perform a write DQ signal training procedure, a write DQS signal training procedure, a read DQ signal training procedure and a read DQS signal training procedure.

As previously described, even if the DQ and DQS signals outputted from the DRAM chips are aligned with each other, but the DQ and DQS signals received by the memory controller usually fail to be aligned with each other. In accordance with the read DQ signal training procedure and the read DQS signal training procedure, the memory controller could adjust the timing of receiving the DQ and DQS signals during the DQ and DQS signals are read. As a consequence, the DQ and DQS signals are aligned with each other, and all DQ signals can be successfully read out.

In accordance with the write DQ signal training procedure and the write DQS signal training procedure, the memory controller could adjust the timing of transmitting the DQ and DQS signals during the DQ and DQS signals are written. As a consequence, the DQ and DQS signals are aligned with each other when the DQ and DQS signals reach the DRAM chips. In other words, even if the DQ and DQS signals outputted from the memory controller are not aligned with each other, the DQ and DQS signals can be aligned with each other when the DQ and DQS signals reach the DRAM chips.

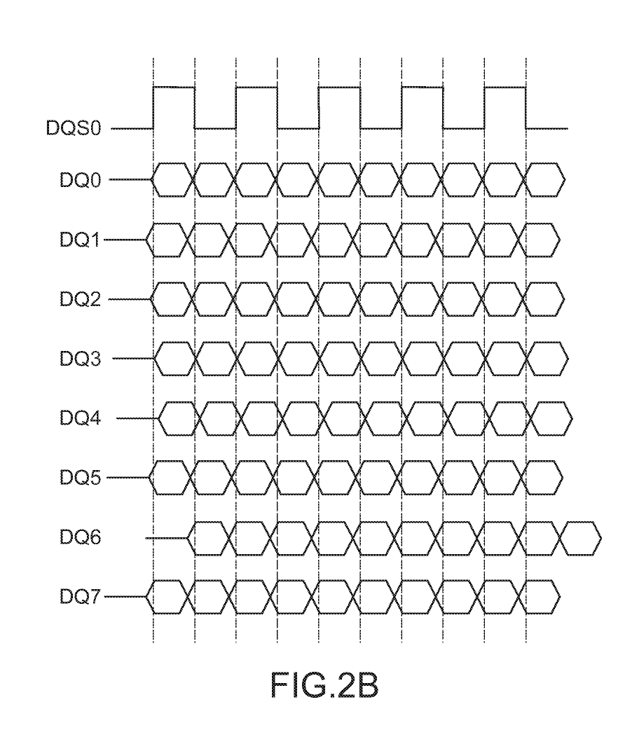

FIG. 3 is a timing waveform diagram illustrating the related DQ and DQS signals processed by the read DQ signal training procedure and the read DQS signal training procedure according to the present invention. As shown in FIG. 3, when the DQ0˜DQ7 signals and the DQS0 signal are transmitted to the receivers, the DQ0˜DQ7 signals usually fail to be aligned with the DQS0 signal. Meanwhile, the memory training program will adjust the relationships between the DQ0˜DQ7 signals and the DQS0 signal such that the DQ0˜DQ7 signals are aligned with the DQS0 signal. For example, as shown in FIG. 3, the DQ6 signal has the largest propagation delay. Assuming that the Δt_{DQ6} is zero, the other DQ signals are delayed according to the DQ6 signal. Since there is a time difference Δt_{DQS0} between the DQS0 signal and the DQ6 signal, the DQS0 signal is delayed by a reading time Δt_{DQS0} according to the memory training program. Similarly, since there is a time difference Δt_{DQ0} between the DQ0 signal and the DQ6 signal, the DQ0 signal is delayed by a reading time Δt_{DQ0} according to the memory training program. Similarly, since there is a time difference Δt_{DQ1} between the DQ1 signal and the DQ6 signal, the DQ1 signal is delayed by a reading time Δt_{DQ1} according to the memory training program. Similarly, since there is a time difference Δt_{DQ2} between the DQ2 signal and the DQ6 signal, the DQ2 signal is delayed by a reading time Δt_{DQ2} according to the memory training program. Similarly, since there is a time difference t_{DQ3} between the DQ3 signal and the DQ6 signal, the DQ3 signal is delayed by a reading time Δt_{DQ3} according to the memory training program. Similarly, since there is a time difference Δt_{DQ4} between the DQ4 signal and the DQ6 signal, the DQ4 signal is delayed by a reading time Δt_{DQ4} according to the memory training program. Similarly, since there is a time difference Δt_{DQ5} between the DQ5 signal and the DQ6 signal, the DQ5 signal is delayed by a reading time Δt_{DQ5} according to the memory training program. Similarly, since there is a time difference Δt_{DQ7} between the DQ7 signal and the DQ6 signal, the DQ7 signal is delayed by a reading time Δt_{DQ7} according to the memory training program.

After the read DQ signal training procedure and the read DQS signal training procedure have been performed, many reading time parameters (i.e. Δt_{DQS0} and Δt_{DQ1}˜Δt_{DQ7}) are obtained.

Similarly, after the write DQ signal training procedure and the write DQS signal training procedure have been performed, many writing time parameters are obtained. After these reading time parameters and these writing time parameters are successfully set, the memory module could be initialized and thus the data could be read out or written into the memory module. On the other hand, if these reading time parameters and these writing time parameters are not successfully set, the initialization of the memory module has a failure and thus the data fails to be read out or written into the memory module.

When the memory training program included in the BIOS is executed by the CPU, the reading time parameters and the writing time parameters obtained from the memory training result are recorded into the non-volatile memory by the CPU, regardless of whether the memory module has been successfully initialized. According to the reading time parameters and the writing time parameters that are stored in the non-volatile memory, the power users could realize whether the memory module has been successfully initiated and understand the relationships between all signals of the memory module. Under this circumstance, the conventional use of the oscilloscope to realize the relationships between all signals of the memory module is not necessary.

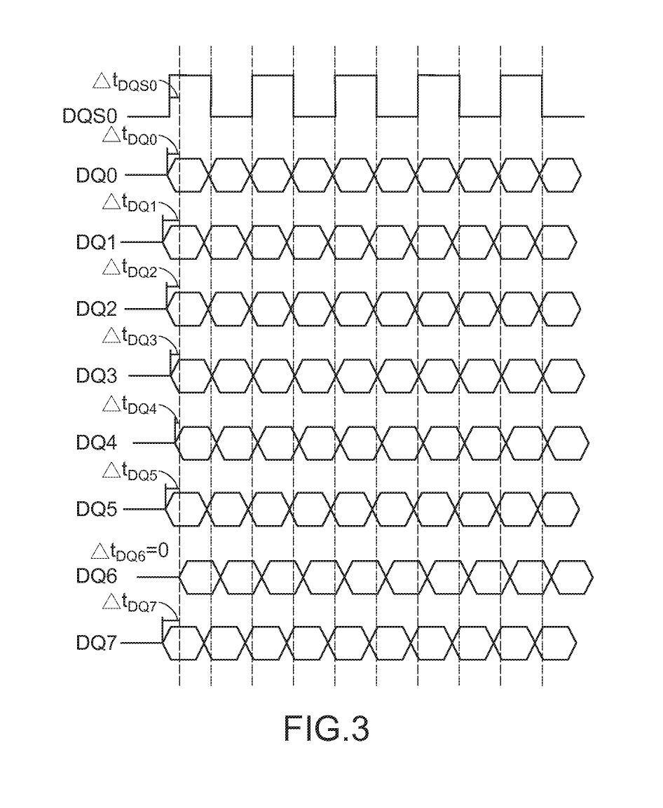

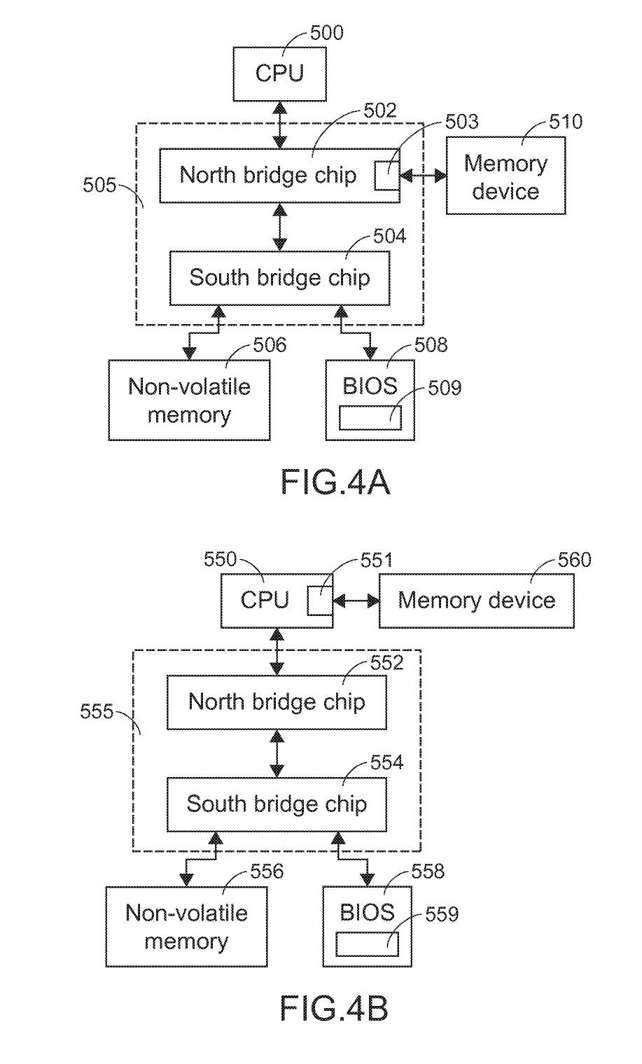

FIG. 4A is a schematic functional block diagram illustrating a computer system for recording the memory training result according to a first embodiment of the present invention. As shown in FIG. 4A, the computer system comprises a central processing unit (CPU) 500, a chipset 505, a BIOS 508, a non-volatile memory 506 (e.g. a flash memory), and a memory device 510. The chipset 505 includes a north bridge chip 502 and a south bridge chip 504. The north bridge chip 502 is connected to the memory device 510, the CPU 500 and the south bridge chip 504. The south bridge chip 504 is connected to the north bridge chip 502, the BIOS 508 and the non-volatile memory 506. The memory device 510 includes at least one memory module (not shown). The BIOS 508 includes a memory training program 509. In addition, a memory controller 503 is integrated into the north bridge chip 502 of the chipset 505.

FIG. 4B is a schematic functional block diagram illustrating a computer system for recording the memory training result according to a second embodiment of the present invention. As shown in FIG. 4B, the computer system comprises a central processing unit (CPU) 550, a chipset 555, a BIOS 558, a non-volatile memory 556 and a memory device 560. The chipset 555 includes a north bridge chip 552 and a south bridge chip 554. The CPU 550 is connected to the memory device 560. The north bridge chip 552 is connected to the CPU 550 and the south bridge chip 554. The south bridge chip 554 is connected to the north bridge chip 552, the BIOS 558 and the non-volatile memory 556. The memory device 560 includes at least one memory module (not shown). The BIOS 558 includes a memory training program 559. In addition, a memory controller 551 is integrated into the CPU 550.

Please refer to FIG. 4A again. During the booting of the computer system, when the memory training program 509 included in the BIOS 508 is executed by the CPU 500, many reading time parameters and many writing time parameters obtained from the memory training result are recorded into the non-volatile memory 506. As a consequence, the designer of the computer system could improve the working performance of the memory module according to the reading time parameters and the writing time parameters.

Moreover, for enhancing the performance of a computer system, some power users may change the BIOS settings of the computer system. Through the BIOS settings, the operating frequency to be used in the memory module could be adjusted as required. For example, overclocking is the process of forcing a computer component to run at a higher clock rate than it was designed or designated by the manufacturer. After the overclocking process involving the memory module is done, the computer system is booted again. According to the reading time parameters and the writing time parameters that are stored in the non-volatile memory, the power users could realize whether the memory module has been successfully initiated and understand the relationships between all signals of the memory module.

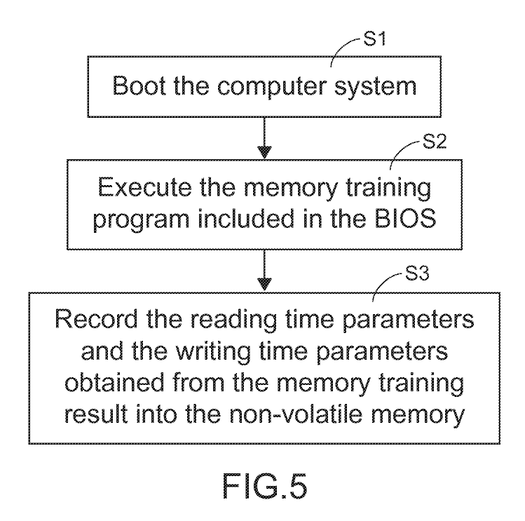

FIG. 5 is a flowchart schematically illustrating a method of detecting the memory training result of the computer system according to the present invention. First of all, the computer system is booted (Step S1).

Then, the memory training program included in the BIOS is executed (Step S2). Afterwards, the reading time parameters and the writing time parameters obtained from the memory training result are recorded into the non-volatile memory (Step S3). According to the reading time parameters and the writing time parameters that are stored in the non-volatile memory, the relationships between all signals of the memory module will be realized.

From the above description, the reading time parameters and the writing time parameters obtained from the memory training result are recorded into the non-volatile memory when the memory training program included in the BIOS is executed during the booting of the computer system. According to the reading time parameters and the writing time parameters that are stored in the non-volatile memory, the relationships between all signals of the memory module will be realized.

Moreover, the concepts of the present invention could be expanded to be applied to a double data rate (DDR) memory module or a double data rate dual in-line memory module (DDR DIMM).

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for detecting a memory training result, the method comprising steps of:
booting a computer system;
executing a memory training program included in a basic input output system of the computer system, thereby obtaining a plurality of reading time parameters and a plurality of writing time parameters; and
recording the reading time parameters and the writing time parameters into a non-volatile memory.

2. The method according to claim 1 wherein the non-volatile memory is a flash memory.

3. The method according to claim 1 wherein the memory training program performs a read DQ signal training procedure and a read DQS signal training procedure, thereby obtaining the reading time parameters.

4. The method according to claim 1 wherein the memory training program performs a write DQ signal training procedure and a write DQS signal training procedure, thereby obtaining the writing time parameters.

5. A computer system for recording a memory training result, the computer system comprising:
a central processing unit;
a memory device including a memory module;
a chipset connected to the memory module and the central processing unit, and including a memory controller;
a basic input output system connected to the chipset, and including a memory training program; and
a non-volatile memory connected to the chipset,
wherein during the booting of the computer system, the central processing unit executes the memory training program to obtain a plurality of reading time parameters and a plurality of writing time parameters, and the reading time parameters and the writing time parameters are recorded into the non-volatile memory.

6. The computer system according to claim 5 wherein the non-volatile memory is a flash memory.

7. The computer system according to claim 5 wherein the memory training program performs a read DQ signal training procedure and a read DQS signal training procedure, thereby obtaining the reading time parameters.

8. The computer system according to claim 5 wherein the memory training program performs a write DQ signal training procedure and a write DQS signal training procedure, thereby obtaining the writing time parameters.

9. The computer system according to claim 5 wherein the memory module is a double data rate memory module.

10. A computer system for recording a memory training result, the computer system comprising:
a central processing unit including a memory controller;
a memory device connected to the central processing unit, and including a memory module;
a chipset connected to the central processing unit;
a basic input output system connected to the chipset, and including a memory training program; and
a non-volatile memory connected to the chipset,
wherein during the booting of the computer system, the central processing unit executes the memory training program to obtain a plurality of reading time parameters and a plurality of writing time parameters, and the reading time parameters and the writing time parameters are recorded into the non-volatile memory.

11. The computer system according to claim 10 wherein the non-volatile memory is a flash memory.

12. The computer system according to claim 10 wherein the memory training program performs a read DQ signal training procedure and a read DQS signal training procedure, thereby obtaining the reading time parameters.

13. The computer system according to claim 10 wherein the memory training program performs a write DQ signal training procedure and a write DQS signal training procedure, thereby obtaining the writing time parameters.

14. The computer system according to claim 10 wherein the memory module is a double data rate memory module.
